(19) United States
(12) Patent Application Publication
(10) Pub. No.: US 2025/0383823 A1
(43) Pub. Date: Dec. 18, 2025

(54) PRINTING APPARATUS, INFORMATION PROCESSING APPARATUS, AND CONTROL METHODS THEREOF

(71) Applicant: CANON KABUSHIKI KAISHA, Tokyo (JP)

(72) Inventor: Ritsuto Sako, Tokyo (JP)

(21) Appl. No.: 19/227,638

(22) Filed: Jun. 4, 2025

(30) Foreign Application Priority Data
Jun. 12, 2024 (JP) 2024-095377

(51) Int. Cl. G06F 3/12; B41J 29/393; G03G 15/00

(52) U.S. Cl. CPC G06F 3/1205; G06F 3/1255; G06F 3/1286; G06F 3/1287; B41J 29/393; G03G 15/5087

(57) ABSTRACT

A printing apparatus receives, from an external apparatus, a print job including a first attribute representing a print setting, generates a print command based on the first attribute, and prints print data designated by the print job, in accordance with the print command. The first attribute includes an attribute name conforming to a first protocol. An attribute name and an attribute value conforming to a second protocol different from the first protocol are included as an attribute value corresponding to the attribute name of the first attribute.

### BACKGROUND

### Field of the Technology

The present disclosure relates to a printing apparatus, an information processing apparatus, and control methods thereof.

### Description of the Related Art

Printing functions have become standard in modern operating systems (OSs). Such printing functions are called “standard printing functions”. To provide users with print settings not supported by standard printing functions, printing apparatus vendors provide Print Support Apps (PSAs) that can be installed in OSs. Standard printing functions communicate with printing apparatuses, print servers, and the like using standard protocols such as the Internet Printing Protocol (IPP). With IPP, the vendor of the printing apparatus can independently define vendor extension attributes. Japanese Patent No. 5665582 proposes a technique for printing in accordance with vendor extension attributes defined for print settings not supported by standard printing functions. Adding vendor extension attributes to the standard printing function of the OS enables the user to use the print settings defined by the vendor extension attributes. However, if vendor extension attributes are defined for each vendor-specific print setting, even if the printing apparatus provides new print settings, the user cannot use those print settings until the vendor extension attributes are added to the standard printing function of the OS.

### SUMMARY

Some aspects of the present disclosure provide a technique for flexibly changing print settings that can be used by a user.

According to some embodiments, a printing apparatus comprising: a receiving unit configured to receive, from an external apparatus, a print job including a first attribute representing a print setting; a generating unit configured to generate a print command based on the first attribute; and a printing unit configured to print print data designated by the print job, in accordance with the print command, wherein the first attribute includes an attribute name conforming to a first protocol; and an attribute name and an attribute value conforming to a second protocol different from the first protocol are included as an attribute value corresponding to the attribute name of the first attribute is provided.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating an example of the configuration of a printing system according to some embodiments.

FIG. 2 is a block diagram illustrating an example of the hardware configuration of a computer according to some embodiments.

FIG. 3 is a block diagram illustrating an example of the functional configuration of a print server according to some embodiments.

FIG. 4 is a block diagram illustrating an example of the functional configuration of an information processing apparatus according to some embodiments.

FIG. 5 is a block diagram illustrating an example of the hardware configuration of a printing apparatus according to some embodiments.

FIG. 6 is a block diagram illustrating an example of the functional configuration of a printing apparatus according to some embodiments.

FIG. 7 is a sequence chart illustrating overall processing for cloud printing according to some embodiments.

FIG. 8 is a sequence chart illustrating overall processing for local printing according to some embodiments.

FIG. 9 is a sequence chart illustrating an example of a method for providing capability information according to some embodiments.

FIG. 10 is a sequence chart illustrating another example of a method for providing capability information according to some embodiments.

FIG. 11 is a sequence chart illustrating another example of a method for providing capability information according to some embodiments.

FIG. 12 is a sequence chart illustrating an example of a method for printing according to some embodiments.

FIG. 13 is a schematic diagram illustrating an example of a method for generating a print command according to some embodiments.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Example of Configuration of Printing System

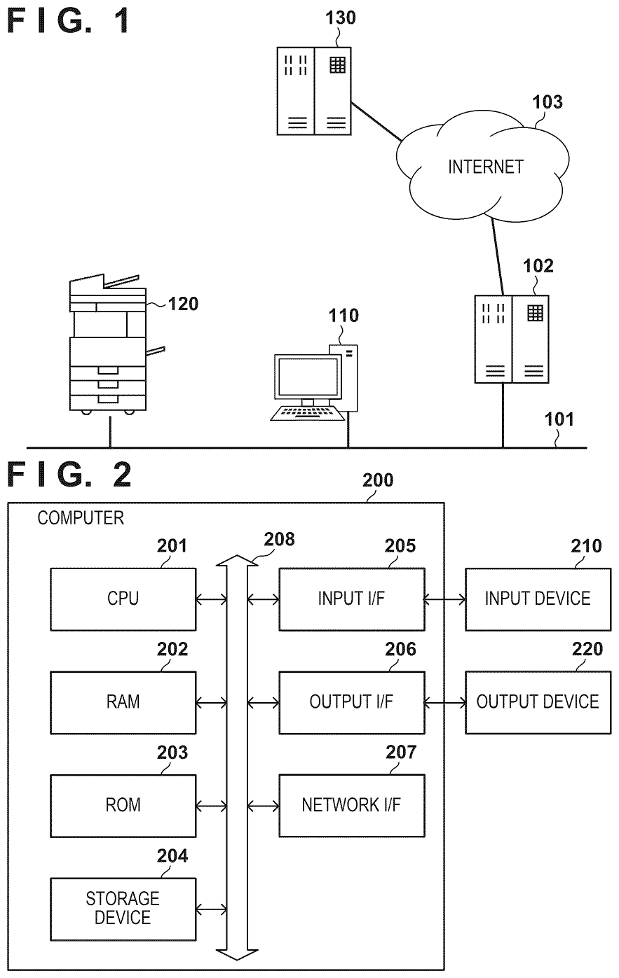

An example of the configuration of a printing system according to some embodiments will be described with reference to FIG. 1. The printing system may be constituted by an information processing apparatus 110 and a printing apparatus 120. However, the printing system may instead be configured by the information processing apparatus 110, the printing apparatus 120, and a print server 130. The printing system may be configured as another combination of the constituent elements illustrated in FIG. 1, or may include constituent elements not illustrated in FIG. 1.

The information processing apparatus 110 and the printing apparatus 120 are connected to the same local area network (LAN) 101. The LAN 101 may be a wired LAN, a wireless LAN, or a combination of the two. The LAN 101 is connected to the Internet 103 through a firewall 102. The print server 130 is also connected to the Internet 103. The Internet 103 may be a wide area network, a cellular network, a local area network, another network, or any combination thereof. The information processing apparatus 110 and the printing apparatus 120 are capable of communicating with each other within the LAN 101 (i.e., not over the Internet 103). The information processing apparatus 110 and the printing apparatus 120 can communicate with the print server 130 through the LAN 101, the firewall 102, and the Internet 103.

The printing apparatus 120 has a printing function for printing in accordance with a print job. The printing apparatus 120 may include at least one of a scanner function and a fax function in addition to the printing function. Such a printing apparatus having multiple functions may be called a multifunction peripheral (MFP). However, the printing apparatus 120 may instead be a single function peripheral (SFP) having only a printing function. The printing may be printing on a sheet-type recording medium such as paper, or may be forming a three-dimensional object (what is known as “three-dimensional printing”).

The print server 130 provides a print service that sends a print job to any one or more printing apparatuses registered in the print server 130 (e.g., the printing apparatus 120) in accordance with a print job generated by the information processing apparatus 110. For example, the print server 130 provides a logical printer to the information processing apparatus 110, and accepts print jobs for the logical printer. “Logical printer” refers to a virtual printing apparatus (e.g., a printer object) provided by the print server 130. The logical printer can also be called a “cloud printer”. The information processing apparatus 110 can generate a print queue for the logical printer. To make a distinction from a logical printer, physical printing apparatuses such as the printing apparatus 120 can also be called “physical printers”. Logical printers and physical printers will be referred to collectively simply as “printers” hereinafter. When connected to the same LAN as the information processing apparatus that submits the print job, the physical printer can also be called a “local printer”.

The print server 130 may be a server in an on-premises environment connected to the Internet 103, or may be a server in a cloud computing environment (called simply “the cloud” hereinafter). A print service provided by the print server 130 in the cloud may also be called a “cloud printing service”. Universal Print (registered trademark), provided by Microsoft, is an example of a cloud printing service. The following will describe a case where the print server 130 is in the cloud. However, the following descriptions also apply when the print server 130 is in an on-premises environment.

The information processing apparatus 110 provides the printing function to the user of the information processing apparatus 110. The information processing apparatus 110 may be a personal computer (PC), a smartphone, or another type of device. The information processing apparatus 110 may designate a physical printer connected to the same LAN 101 (e.g., the printing apparatus 120) as an output destination for printed materials. Printing performed by submitting a print job directly to a physical printer (i.e., on the LAN) can also be called “local printing”.

The information processing apparatus 110 may designate a logical printer provided by the print server 130 as the output destination for printed materials. When a logical printer is designated as the output destination, a physical printer associated with the logical printer (e.g., the printing apparatus 120) performs the printing. The information processing apparatus 110 that uses the cloud printing service may be called a “client” or “client terminal”. Printing performed in response to a print job being submitted to a logical printer can also be called “cloud printing” or “remote printing”. Printing performed in response to a print job being submitted to a logical printer may be executed by the printing apparatus 120 connected to the same LAN 101 as the information processing apparatus 110, or may be executed by a printing apparatus not connected to the LAN 101.

In the example in FIG. 1, the information processing apparatus 110 is capable of executing both local printing and remote printing. However, the information processing apparatus 110 may instead be capable of executing only one of local printing and remote printing.

The information processing apparatus 110 may have a printing function included as standard in the operating system (OS). Such a printing function is called a “standard printing function”. The standard printing function can also be called an “OS standard printing function” or a “native printing function”. The information processing apparatus 110 having a standard printing function does not require separate software (e.g., drivers) to use printing apparatuses that support the standard printing function. Examples of standard printing functions include AirPrint (registered trademark), which is included as standard in iOS (registered trademark), macOS (registered trademark), and the like, and Mopria (registered trademark), which is included as standard in Windows (registered trademark), Android (registered trademark), and the like.

### Example of Computer Hardware Configuration

An example of the hardware configuration of a computer 200 according to some embodiments will be described with reference to FIG. 2. The computer 200 may be used as the information processing apparatus 110, or may be used as the print server 130. The computer 200 may include the constituent elements illustrated in FIG. 2; may omit some of the constituent elements illustrated in FIG. 2; or may include constituent elements not illustrated in FIG. 2.

A central processing unit (CPU) 201 is a general-purpose processing circuit that controls the overall operations of the computer 200. A random access memory (RAM) 202 is a volatile memory circuit and is used as a temporary storage region, such as a work area for processing by the CPU 201. A read-only memory (ROM) 203 is a non-volatile memory circuit, and stores programs, data, and the like used in processing by the CPU 201. A storage device 204 is a non-volatile storage device, and stores programs, data, and the like used in processing by the CPU 201. The storage device 204 may be a hard disk drive (HDD), a solid-state drive (SSD), or the like, for example. The storage device 204 can also be called a secondary storage device. Operations by the computer 200 may be implemented by the CPU 201 executing programs read out from the storage device 204 into the RAM 202.

An input interface (I/F) 205 is an I/F for exchanging signals with an input device 210. The input device 210 is a device that obtains inputs from a user of the computer 200. The input device 210 may be a keyboard, a touch panel, a microphone, a mouse, or any combination thereof, for example. An output I/F 206 is an I/F for exchanging signals with an output device 220. The output device 220 is a device that provides information to the user of the computer 200. The output device 220 may be a display, a speaker, or any combination thereof, for example. A network I/F 207 is an I/F for communicating with devices outside the computer 200. The CPU 201, the RAM 202, the ROM 203, the storage device 204, the input I/F 205, the output I/F 206, and the network I/F 207 are each connected to a system bus 208. In the example in FIG. 2, the input device 210 and the output device 220 are illustrated as devices separate from the computer 200. However, the computer 200 may instead include the input device 210 and the output device 220.

### Example of Functional Configuration of Print Server

An example of the functional configuration of the print server 130 will be described with reference to FIG. 3. The print server 130 may include the constituent elements illustrated in FIG. 3; may omit some of the constituent elements illustrated in FIG. 3; or may include constituent elements not illustrated in FIG. 3. The constituent elements in FIG. 3 may be implemented by the CPU 201 executing programs read out into the RAM 202. However, some or all of the constituent elements in FIG. 3 may instead be implemented by dedicated processing circuits such as application-specific integrated circuits (ASICs).

A registration control unit 301 performs processing for registering a logical printer. For example, the registration control unit 301 generates a logical printer associated with a physical printer and registers the logical printer in printer information 311 in response to a registration start request from the printing apparatus 120. The logical printer registered in the printer information 311 is recognized as a printer by the information processing apparatus 110. The physical printer associated with the logical printer may be a physical printer that prints in accordance with print jobs submitted to the logical printer. The configuration may be such that the logical printer is associated with only a single physical printer. The configuration may also be such that the physical printer is associated with only a single logical printer, or with a plurality of logical printers.

A print control unit 302 performs processing related to print jobs for the logical printer. For example, the print control unit 302 receives a print job for the logical printer from the information processing apparatus 110, and on the basis thereof, sends the print job to the physical printer associated with the logical printer. The print control unit 302 may also control events associated with print jobs. Events associated with print jobs may include receiving a print job, for example. In response to receiving an event request from a physical printer, the print control unit 302 may respond with an event associated with that physical printer.

A printer management unit 303 manages information about the logical printer registered in the print server 130 as the printer information 311. The printer information 311 includes capability information of the physical printer associated with the logical printer, a cloud printer ID uniquely assigned to the logical printer, information about a print queue in which print jobs are spooled, and the like.

A job management unit 304 manages information about a print job received from the information processing apparatus 110 as job information 312. The job information 312 includes the information, status, and the like of the print job, print data designated in the print job, and the like.

A storage control unit 310 stores information in the RAM 202 and the storage device 204, reads out information from the RAM 202 and the storage device 204, and the like in accordance with instructions from other constituent elements. According to some embodiments, the storage control unit 310 stores the printer information 311 and the job information 312.

### Example of Functional Configuration of Information Processing Apparatus

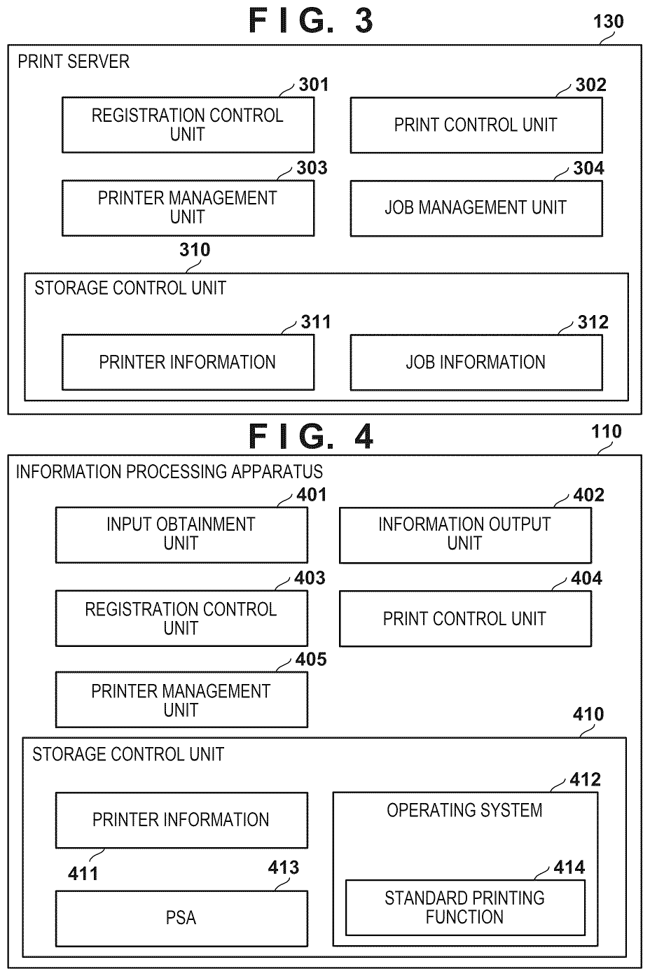

An example of the functional configuration of the information processing apparatus 110 will be described with reference to FIG. 4. The information processing apparatus 110 may include the constituent elements illustrated in FIG. 4; may omit some of the constituent elements illustrated in FIG. 4; or may include constituent elements not illustrated in FIG. 4. The constituent elements in FIG. 4 may be implemented by the CPU 201 executing programs read out into the RAM 202. However, some or all of the constituent elements in FIG. 4 may instead be implemented by dedicated processing circuits such as ASICs.

An input obtainment unit 401 obtains inputs from the user of the information processing apparatus 110 using the input I/F 205. An information output unit 402 outputs information to the user of the information processing apparatus 110 using the output I/F 206.

A registration control unit 403 performs processing for registering a logical printer in the print server 130. A print control unit 404 performs processing related to printing by the printer. For example, the print control unit 404 may send a print job to a logical printer registered in the print server 130 in accordance with a print instruction from the user of the information processing apparatus 110. The print control unit 404 may send the print job directly to a physical printer (i.e., over the same LAN) in accordance with the print instruction from the user of the information processing apparatus 110.

A printer management unit 405 manages information about printers to which the information processing apparatus 110 can submit print jobs as printer information 411. The printer information 411 includes capability information of the printer and the like. The printer management unit 405 may search for printers to which the information processing apparatus 110 can submit print jobs.

A storage control unit 410 stores information in the RAM 202 and the storage device 204, reads out information from the RAM 202 and the storage device 204, and the like in accordance with instructions from other constituent elements. According to some embodiments, the storage control unit 410 stores the printer information 411 and an operating system (OS) 412. The OS 412 is installed in the information processing apparatus 110 as standard (i.e., when the information processing apparatus 110 is shipped). The OS 412 may be updated. The OS 412 has functions for basic management and control of the information processing apparatus 110. The OS 412 includes a standard printing function 414.

The storage control unit 410 may further store the Print Support Application (PSA) 413. The PSA 413 is an application (plugin) installed in the OS 412 to extend the standard printing function 414. The PSA 413 is provided by the vendor of the printing apparatus 120. The PSA 413 makes it possible for users of the information processing apparatus 110 to use print settings not supported by the standard printing function 414.

The standard printing function 414 may support a standard protocol. “Supporting” a protocol may be interpreting commands conforming to the protocol and operating in accordance with the commands. The standard protocol supported by the standard printing function 414 may be a protocol standardized by a standardization body, or may be a de facto standard protocol. The following will describe a case where the standard protocol supported by the standard printing function 414 is the Internet Printing Protocol (IPP). The following descriptions pertaining to the IPP also apply to other standard protocols.

The PSA 413 may support a protocol different from the standard protocol supported by the standard printing function 414. The standard printing function 414 need not support the protocol supported by the PSA 413. The protocol supported by the PSA 413 may be a standard protocol different from the standard protocol supported by the standard printing function 414. For example, the protocol supported by the PSA 413 may be a proprietary protocol of the vendor of the printing apparatus 120. The following will describe a case where the protocol supported by the PSA 413 is a Common Peripheral Controlling Architecture (CPCA). The CPCA is a proprietary protocol of the vendor of the printing apparatus 120. The following descriptions of the CPCA also apply to other protocols different from the standard protocol supported by the standard printing function 414.

### Example of Hardware Configuration of Printing Apparatus

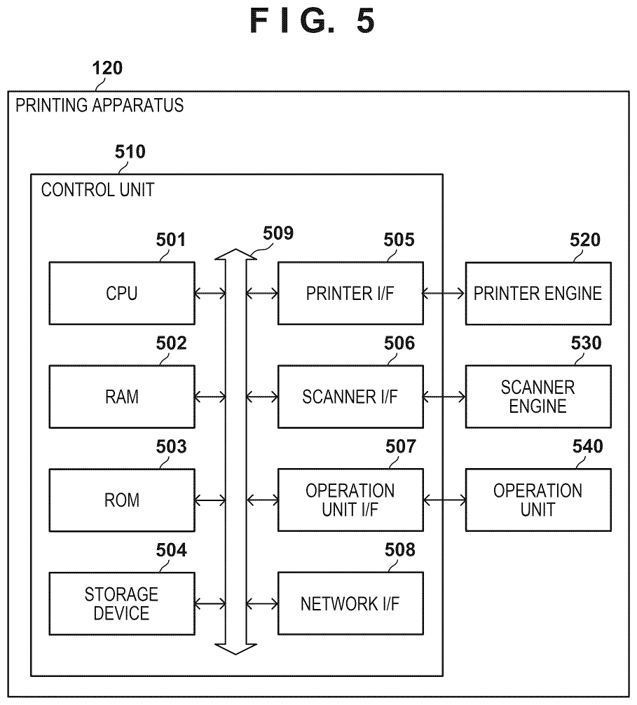

An example of the hardware configuration of the printing apparatus 120 according to some embodiments will be described with reference to FIG. 5. The printing apparatus 120 may include the constituent elements illustrated in FIG. 5; may omit some of the constituent elements illustrated in FIG. 5; or may include constituent elements not illustrated in FIG. 5. The printing apparatus 120 is a physical printing apparatus and can therefor also be called a “physical printer”.

A CPU 501 is a general-purpose processing circuit that controls the overall operations of the printing apparatus 120. A RAM 502 is a volatile memory circuit and is used as a temporary storage region, such as a work area for processing by the CPU 501. AROM 503 is a non-volatile memory circuit, and stores programs, data, and the like used in processing by the CPU 501. A storage device 504 is a non-volatile storage device, and stores programs, data (e.g., print jobs, image data, and setting information), and the like used in processing by the CPU 501. The storage device 504 may be an HDD, an SSD, or the like, for example. The storage device 504 can also be called a secondary storage device. Operations by the printing apparatus 120 may be implemented by the CPU 501 executing programs read out from the storage device 504 into the RAM 502.

A printer I/F 505 is an I/F for exchanging signals with a printer engine 520. The printer engine 520 prints based on signals supplied by a control unit 510 through the printer I/F 505 (e.g., image signals, print commands, or the like). The printing may be electrophotographic printing in which toner is transferred and fixed onto paper, ink jet printing in which ink is ejected onto paper, three-dimensional printing, or the like.

A scanner I/F 506 is an I/F for exchanging signals with a scanner engine 530. The scanner engine 530 supplies a signal (e.g., an image signal) obtained by reading a document to the control unit 510 through the scanner I/F 506. The CPU 501 may process the image signal supplied by the scanner engine 530 and supply a resulting recorded image signal to the printer engine 520. The CPU 501 may also generate image data based on the image signal supplied by the scanner engine 530 and send the image data to an external apparatus.

An operation unit I/F 507 is an I/F for exchanging signals with an operation unit 540. The operation unit 540 is a device that obtains inputs from the user of the printing apparatus 120 and provides information to the user of the printing apparatus 120. The operation unit 540 may be configured as a display panel (e.g., a liquid crystal display), a speaker, a touch panel, a keyboard, buttons, a touchscreen, or any combination thereof, for example.

A network I/F 508 is an I/F for communicating with an apparatus outside the printing apparatus 120. The control unit 510 is constituted by the CPU 501, the RAM 502, the ROM 503, the storage device 504, the printer I/F 505, the scanner I/F 506, the operation unit I/F 507, and the network I/F 508. The various constituent elements included in the control unit 510 are connected to a system bus 509.

### Example of Functional Configuration of Printing Apparatus

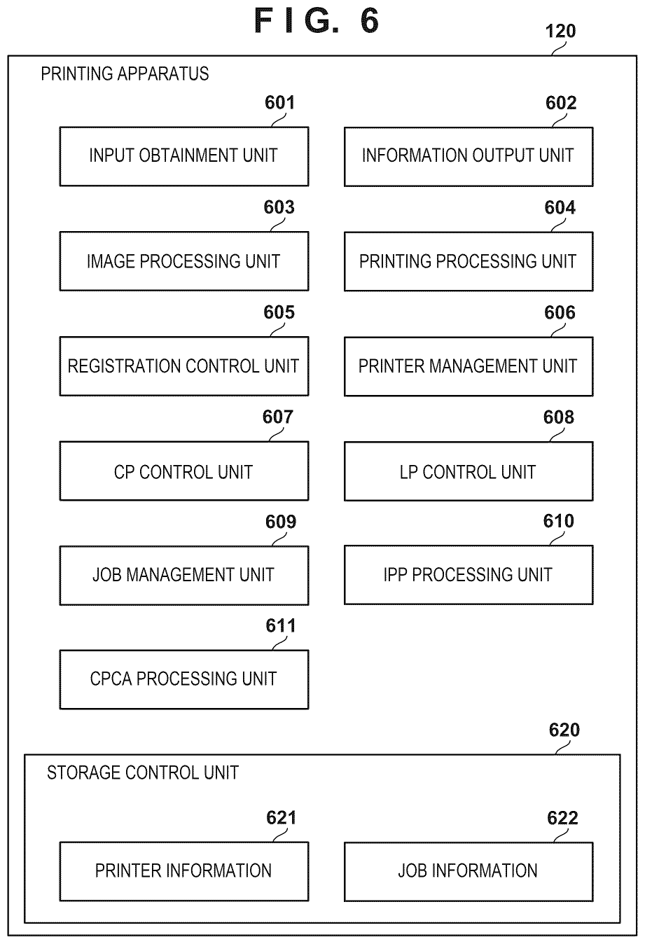

An example of the functional configuration of the printing apparatus 120 will be described with reference to FIG. 6. The printing apparatus 120 may include the constituent elements illustrated in FIG. 6; may omit some of the constituent elements illustrated in FIG. 6; or may include constituent elements not illustrated in FIG. 6. The constituent elements in FIG. 6 may be implemented by the CPU 501 executing programs read out into the RAM 502. However, some or all of the constituent elements in FIG. 6 may instead be implemented by dedicated processing circuits such as ASICs.

An input obtainment unit 601 obtains inputs from the user of the printing apparatus 120 using the operation unit I/F 507. An information output unit 602 outputs information to the user of the printing apparatus 120 using the operation unit I/F 507. For example, the information output unit 602 displays an operation menu in the operation unit 540. The input obtainment unit 601 obtains inputs made to the operation menu, and notifies other constituent elements of the details of input instructions. The information output unit 602 displays results obtained from other constituent elements on the operation unit 540.

An image processing unit 603 renders print jobs into image data for printing. A printing processing unit 604 prints the image data rendered by the image processing unit 603.

A registration control unit 605 performs processing for registering a logical printer associated with the printing apparatus 120 in the print server 130. A printer management unit 606 manages information about the printing apparatus 120 as printer information 621. The printer information 621 may include the status of the printing apparatus 120, capability information of the printing apparatus 120, and a cloud printer ID uniquely assigned by the print server 130 to the logical printer associated with the printing apparatus 120, for example. Additionally, the printer information 621 may include a local printer ID for the information processing apparatus 110 to identify printing apparatuses on the same LAN 101. The capability information of the printing apparatus 120 is information about the capabilities of the printing apparatus 120, and may include an indication that the printing apparatus 120 has a specific function, for example.

A cloud print (CP) control unit 607 performs processing pertaining to cloud printing. For example, by transferring the print data included in a print job received from the print server 130 to the image processing unit 603, the CP control unit 607 may execute printing in accordance with the print job sent from the print server 130. The CP control unit 607 may also send event requests to the print server 130.

A local print (LP) control unit 608 performs processing pertaining to local printing. For example, the LP control unit 608 may respond to a printer search from the information processing apparatus 110. Additionally, by transferring the print data included in a print job received directly from the information processing apparatus 110 to the image processing unit 603, the LP control unit 608 may execute printing in accordance with the print job sent from the information processing apparatus 110. A job management unit 609 manages information about print jobs as job information 622. The job information 622 may include the processing status, processing results, and the like of the print job.

An IPP processing unit 610 performs processing pertaining to the IPP. For example, the IPP processing unit 610 receives a message conforming to the IPP from an external apparatus (the information processing apparatus 110 or the print server 130), interprets the message, and executes the processing designated in the message. The IPP processing unit 610 may have a server function. For example, a specific port number may be assigned to the IPP processing unit 610, and a message designating this port number may be passed to the IPP processing unit 610.

A CPCA processing unit 611 performs processing pertaining to the CPCA. For example, the CPCA processing unit 611 receives a message conforming to the CPCA from an external apparatus (the information processing apparatus 110 or the print server 130), interprets the message, and executes the processing designated in the message. The CPCA processing unit 611 may have a server function. For example, a specific port number may be assigned to the CPCA processing unit 611, and a message designating this port number may be passed to the CPCA processing unit 611. The message to the CPCA processing unit 611 may be passed from another constituent element of the printing apparatus 120 (e.g., the IPP processing unit 610) in a local loopback. The CPCA processing unit 611 may also provide an application programming interface (API), and may obtain instructions from other constituent elements (e.g., the IPP processing unit 610) through the API.

A storage control unit 620 stores information in the RAM 502 and the storage device 504, reads out information from the RAM 502 and the storage device 504, and the like in accordance with instructions from other constituent elements. According to some embodiments, the storage control unit 620 stores the printer information 621 and the job information 622. The storage control unit 620 may manage the data in a file system. The storage control unit 620 may assign the storage location of each type of data to the storage device 504, which is a non-volatile region, or the RAM 502, which is a volatile region. For example, the storage control unit 620 may store the printer information 621 and the job information 622 in the non-volatile region.

### Overall Cloud Print Processing Sequence

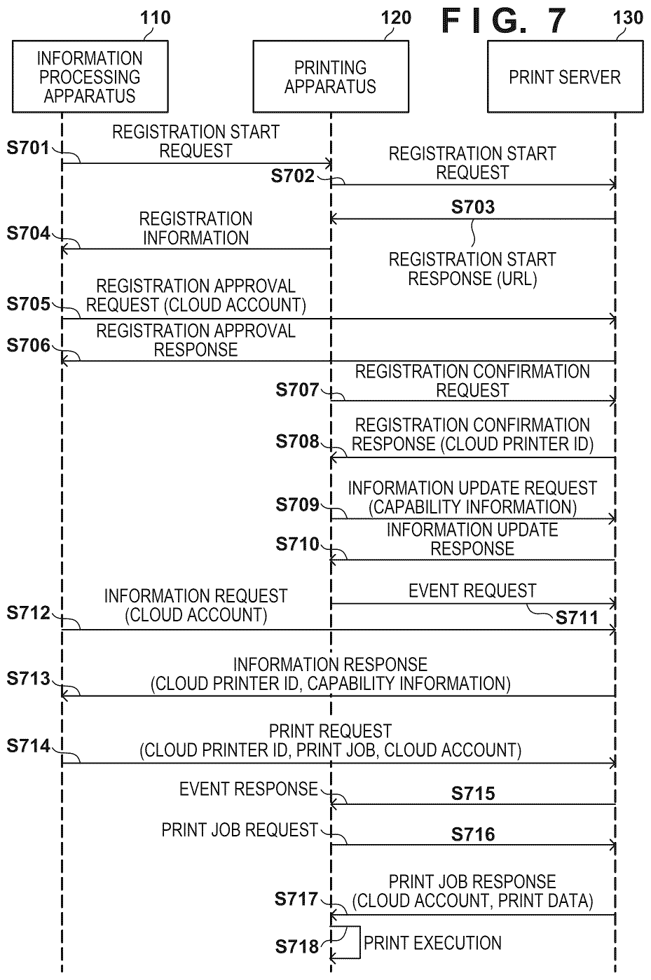

An overall sequence of processing for performing cloud printing will be described with reference to FIG. 7. The example in FIG. 7 illustrates a case where the information processing apparatus 110 registers the printing apparatus 120 in the print server 130 and submits a print job to the logical printer associated with the printing apparatus 120. Registering the printing apparatus 120 in the print server 130 may correspond to registering a logical printer associated with the printing apparatus 120 in the print server 130. The following example will assume that the printing apparatus 120 supports a web user interface (UI) function for operating the printing apparatus 120 from the information processing apparatus 110. It is also assumed that the information processing apparatus 110 supports a web UI client function. The information processing apparatus 110, the printing apparatus 120, and the print server 130 may communicate with each other using the Internet Printing Protocol (IPP).

In step S701, the registration control unit 403 of the information processing apparatus 110 sends a registration start request to the printing apparatus 120 in accordance with an instruction from the user of the information processing apparatus 110. The registration start request may be a request to start processing for registering the printing apparatus 120 in the print server 130. The registration start request may be sent using the web UI client function of the information processing apparatus 110.

In step S702, the registration control unit 605 of the printing apparatus 120 sends the registration start request to the print server 130 in response to receiving the registration start request from the information processing apparatus 110. The registration start request may be a request to start processing for registering the printing apparatus 120 in the print server 130.

In step S703, the registration control unit 301 of the print server 130 sends a registration start response to the printing apparatus 120 in response to the registration start request being received from the printing apparatus 120. The registration start response includes a Uniform Resource Locator (URL) of a web page for the user of the information processing apparatus 110 to input information for registering the printing apparatus 120 in the print server 130.

In step S704, the registration control unit 605 of the printing apparatus 120 sends registration information to the information processing apparatus 110 in response to receiving the registration start response from the print server 130. The registration information includes the URL included in the registration start response. The information output unit 402 of the information processing apparatus 110 displays the web page to the user in response to the registration information being received from the printing apparatus 120.

In step S705, the registration control unit 403 of the information processing apparatus 110 sends a registration approval request to the print server 130 in response to the user of the information processing apparatus 110 accessing the URL and inputting information necessary for registration. The registration approval request includes a cloud account of the user of the information processing apparatus 110. The cloud account is an account for the user to use a tenant in the cloud including the print server 130.

In step S706, the registration control unit 301 of the print server 130 confirms whether the cloud account included in the registration approval request belongs to a user who has the authority to register the printing apparatus 120 in the print server 130. If the user has such authority, the registration control unit 301 of the print server 130 sends a registration approval response to the information processing apparatus 110. The registration approval response may be a message communicating a confirmation result that indicates the user of the information processing apparatus 110 is a user who has the authority to register the printing apparatus 120.

In step S707, the printer management unit 606 of the printing apparatus 120 sends a registration confirmation request to the print server 130 in response to the registration start response being received from the print server 130. The registration confirmation request is a request for registering the printing apparatus 120 in the print server 130, and may specifically be a request for registering the printing apparatus 120 in the print server 130.

In step S708, the printer management unit 303 of the print server 130 generates a new logical printer, and adds the logical printer to the printer information 311 in association with the printing apparatus 120, in response to the registration confirmation request being received from the printing apparatus 120. As a result, the printing apparatus 120 is registered in the print server 130, and the information processing apparatus 110 is capable of cloud printing using the logical printer. Additionally, the printer management unit 303 of the print server 130 assigns a unique cloud printer ID to the generated logical printer, and adds the cloud printer ID to the printer information 311 in association with the logical printer. Then, the registration control unit 301 of the print server 130 sends a registration confirmation response to the printing apparatus 120. The registration confirmation response includes a cloud printer ID of the printing apparatus 120.

In step S709, the printer management unit 606 of the printing apparatus 120 sends an information update request to the print server 130 in response to the registration of the printing apparatus 120 in the print server 130 being completed. The information update request may be a request to update the information about the printing apparatus 120. The information update request includes the capability information of the printing apparatus 120. The information update request may be sent using the Update-Output-Device-Attributes Request message defined by the IPP.

In step S710, the printer management unit 303 of the print server 130 updates the information about the printing apparatus 120 included in the printer information 311 based on the capability information included in the received information update request, and sends an information update response to the printing apparatus 120. The information update response may be a message indicating that the updating of the information about the printing apparatus 120 has been successfully completed.

In step S711, the CP control unit 607 of the printing apparatus 120 sends an event request to the print server 130 in response to the registration confirmation response being received from the print server 130. The event request may be a request to notify the printing apparatus 120 when an event related to the printing apparatus 120 occurs. The event request may be related to an event in which a print job has been submitted to the logical printer associated with the printing apparatus 120.

In step S712, the printer management unit 405 of the information processing apparatus 110 sends an information request to the print server 130 in accordance with an instruction from the user of the information processing apparatus 110. The information request may be a request for information about a logical printer that can be used by the user of the information processing apparatus 110. The information request includes the cloud account of the user of the information processing apparatus 110. The information request may be sent using the Get-Printer-Attributes Request message defined by the IPP.

In step S713, the printer management unit 303 of the print server 130 sends an information response to the information processing apparatus 110 in response to the information request being received from the information processing apparatus 110. The information response includes the cloud printer ID and the capability information for each of the one or more logical printers that can be used by the user of the information processing apparatus 110. The printer management unit 405 of the information processing apparatus 110 updates the printer information 411 based on the information response. The discovered logical printer is registered in the standard printing function 414 of the information processing apparatus 110 as a result. The information response may be sent using the Get-Printer-Attributes Response message defined by the IPP.

In step S714, the printer management unit 405 of the information processing apparatus 110 sends a print request to the print server 130 in accordance with an instruction from the user of the information processing apparatus 110. The print request includes the cloud printer ID, the print job, and the cloud account of the user of the information processing apparatus 110. The print job may include print data and print settings. The print request may be a request made to the logical printer having the cloud printer ID included in the print request, to print the print data included in the print request. The information processing apparatus 110 may instruct the logical printer registered in the standard printing function 414 to print.

In step S715, the print control unit 302 of the print server 130 sends an event response to the printing apparatus 120 associated with the logical printer in response to the print request being received from the information processing apparatus 110. The event response is a response to the event request received in step S711. The event response is a response for making a notification that an event of a type designated in the event request has occurred.

In step S716, the CP control unit 607 of the printing apparatus 120 sends a print job request to the print server 130 in response to the event response being received from the print server 130. The print job request may be a request for a print job that is to be executed by the printing apparatus 120.

In step S717, the print control unit 302 of the print server 130 sends a print job response to the printing apparatus 120 in response to the print job request being received from the printing apparatus 120. The print job response includes the cloud account and the print job. The print job response received by the printing apparatus 120 from the print server 130 may be a Fetch-Job Response message defined in the IPP. In step S718, the printing apparatus 120 prints in accordance with the print job, in response to the print job response being received from the print server 130.

In the descriptions of FIG. 7, the registration of the printing apparatus 120 in steps S701 to S706 and the cloud printing in steps S712 to S718 may be performed by the same user, or by different users.

### Overall Local Print Processing Sequence

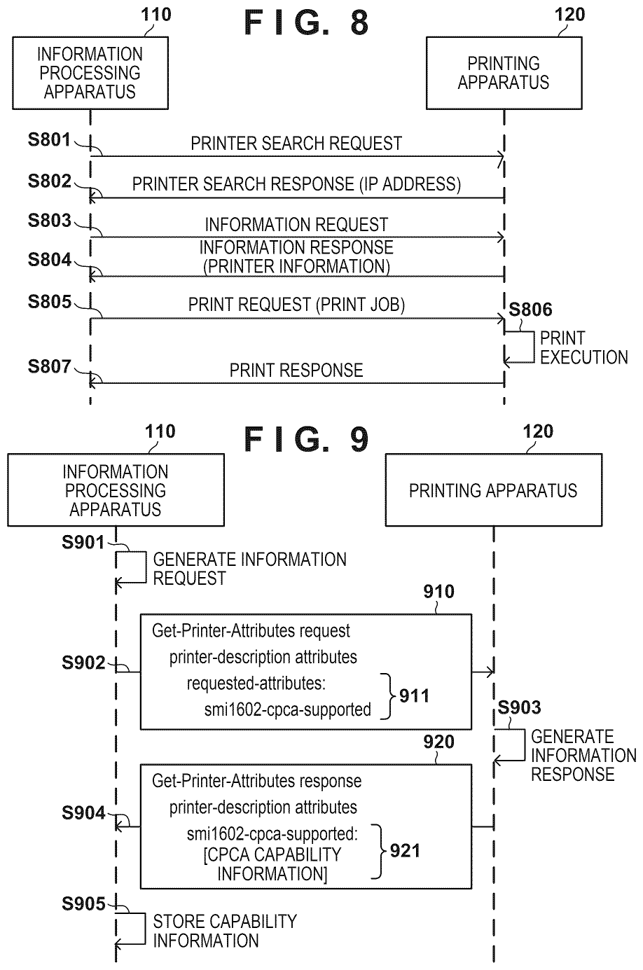

An overall sequence of processing for performing local printing will be described with reference to FIG. 8. The example in FIG. 8 illustrates a case where the information processing apparatus 110 submits a print job to the printing apparatus 120 connected to the same network (i.e., the LAN 101) as the information processing apparatus 110. The information processing apparatus 110 and the printing apparatus 120 may communicate using the IPP. The information processing apparatus 110 and the printing apparatus 120 communicate within the LAN 101, and not over the Internet 103.

In step S801, the printer management unit 405 of the information processing apparatus 110 sends a printer search request to the network to which the information processing apparatus 110 is connected (i.e., the LAN 101) using the standard printing function 414, in accordance with an instruction from the user of the information processing apparatus 110. The printer search request may be performed by broadcasting to the LAN 101. The printer search request may be a request to make a response as to whether a printer supporting the standard printing function 414 is present.

In step S802, the LP control unit 608 of the printing apparatus 120 that supports the standard printing function 414 sends a printer search response to the information processing apparatus 110 in response to the printer search request. The printer search response may include an Internet Protocol (IP) address of the printing apparatus 120. A printing apparatus that does not support the standard printing function 414 or in which the standard printing function 414 is disabled need not respond to the printer search request. The printer management unit 405 of the information processing apparatus 110 stores the IP address of the printing apparatus 120 that sent the printer search response in the storage control unit 410 as part of the printer information 411. The printing apparatus 120 that has been discovered is registered in the standard printing function 414 as a result. Additionally, the information output unit 402 of the information processing apparatus 110 may present a list of discovered printing apparatuses to the user.

In step S803, the printer management unit 405 of the information processing apparatus 110 sends an information request to the printing apparatus 120. The information request may be a request for information about the printing apparatus 120. The information request may be sent using the Get-Printer-Attributes Request message defined by the IPP.

In step S804, the printer management unit 606 of the printing apparatus 120 sends an information response to the information processing apparatus 110 in response to the information request being received from the information processing apparatus 110. The information response includes the capability information of the printing apparatus 120. The printer management unit 405 of the information processing apparatus 110 updates the printer information 411 based on the information response. The information response may be sent using the Get-Printer-Attributes Response message defined by the IPP.

In step S805, the print control unit 404 of the information processing apparatus 110 sends a print request to the printing apparatus 120 using the standard printing function 414 in accordance with an instruction from the user of the information processing apparatus 110. The print request includes a print job. The print job may include print data and print settings. The print request may be a request made to the printing apparatus 120 to print the print data included in the print request.

In step S806, the LP control unit 608 of the printing apparatus 120 prints in accordance with the received print job. The LP control unit 608 of the printing apparatus 120 sends the result of the printing to the information processing apparatus 110 as a print response.

Operations by which Information Processing Apparatus Obtains Capability Information

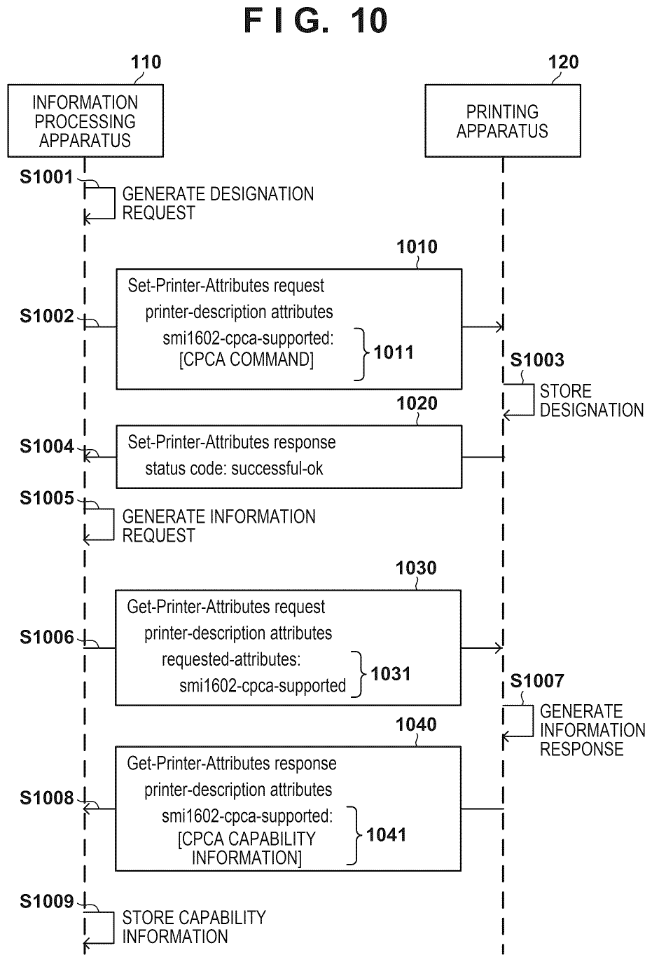

A specific example of steps S803 and S804 illustrated in FIG. 8 will be described with reference to FIG. 9. Steps S901 and S902 in FIG. 9 are executed in step S803 in FIG. 8, and steps S903 to S905 in FIG. 9 are executed in step S804 in FIG. 8.

In step S901, the standard printing function 414 of the information processing apparatus 110 generates an information request 910. As described above, the information request 910 may be a message requesting information about the printing apparatus 120. In the example in FIG. 9, the information request 910 is a Get-Printer-Attributes Request message defined by the IPP.

Messages defined by the IPP include at least one attribute. An “attribute” is an item of information. The attribute includes an attribute name and an attribute value. The attribute name indicates the type of information expressed by the attribute. The attribute value indicates a specific value of the information expressed by the attribute name. The format of the attribute name and the format of the attribute value are defined by the IPP. In the following descriptions, an attribute having an attribute name of “(specific character string)” will be referred to as an attribute “(specific character string)”.

The Get-Printer-Attributes Request message can include an attribute “requested-attributes”. The attribute “requested-attributes” indicates a request for capability information of the type designated by the attribute value. The attribute “requested-attributes” not being included in the Get-Printer-Attributes Request message may indicate that all the types of the capability information of the printing apparatus 120 are requested. The attribute “requested-attributes” may include an attribute value defined by the IPP and an attribute value defined by the vendor.

In the example in FIG. 9, the information request 910 includes an attribute 911 representing a request for the capability information expressed in a format conforming to the CPCA. Capability information expressed in a format conforming to the CPCA will be referred to as “CPCA capability information” hereinafter. In the example in FIG. 9, the attribute name of the attribute 911 is “requested-attributes”. The attribute name of the attribute 911 conforms to the IPP. The attribute value of the attribute 911 is “smi1602-cpca-supported”. The attribute value of the attribute 911 conforms to the IPP. Because both the attribute name and the attribute value of the attribute 911 conform to the IPP in this manner, the standard printing function 414 can generate an information request 910 including the attribute 911.

The “smi” at the beginning of the attribute value of the attribute 911 indicates that the attribute value is an attribute value defined by the vendor. The “1602” following “smi” is a numerical value assigned to the specific vendor. The character string following “1602” is a character string defined as desired by the vendor. The attribute value of the attribute 911 indicates the type of the requested capability information. The attribute value of the attribute 911 including “smi1602-cpca-supported” may indicate a request for the CPCA capability information. The CPCA capability information can also express print settings not supported by the standard printing function 414. The attribute 911 may include other attribute values in addition to “smi1602-cpca-supported”. Additionally, the information request 910 may include other attributes.

In step S902, the printer management unit 405 of the information processing apparatus 110 sends the information request 910 to the printing apparatus 120, and the printing apparatus 120 receives the information request 910. For example, the printer management unit 405 of the information processing apparatus 110 sends the information request 910 to the printing apparatus 120 by specifying the port number assigned to the IPP processing unit 610 of the printing apparatus 120. In this case, the information request 910 is passed to the IPP processing unit 610 of the printing apparatus 120.

In step S903, the IPP processing unit 610 of the printing apparatus 120 generates an information response 920 in response to the information request 910 being received. As described above, the information response 920 includes the capability information of the printing apparatus 120. In the example in FIG. 9, the information response 920 is a Get-Printer-Attributes Response message defined by the IPP.

First, the IPP processing unit 610 identifies that the capability information of the printing apparatus 120 is being requested based on the information request 910 being received. The IPP processing unit 610 further identifies that the CPCA capability information is being requested based on the attribute value of the attribute “requested-attributes” being “smi 1602-cpca-supported” (i.e., the information request 910 including the attribute 911). The IPP processing unit 610 then queries the CPCA processing unit 611 for the CPCA capability information. This query may be made using the port number of the CPCA processing unit 611, or may be made using the API of the CPCA processing unit 611.

The CPCA processing unit 611 obtains the CPCA capability information of the printing apparatus 120 from the printer information 621 and returns the CPCA capability information to the IPP processing unit 610. The CPCA capability information may represent a type of the capability information set in the printing apparatus 120 in advance. The type of the capability information set in advance may be any type of capability information that the printing apparatus 120 has. The CPCA capability information may include a plurality of types of print settings of the printing apparatus 120. The CPCA capability information can also express print settings not supported by the standard printing function 414. If the printing apparatus 120 does not have print settings not supported by the standard printing function 414, the CPCA capability information does not include print settings not supported by the standard printing function 414.

The IPP processing unit 610 generates the information response 920 based on the CPCA capability information returned from the CPCA processing unit 611. Specifically, the information response 920 includes an attribute 921. The attribute name of the attribute 921 is an attribute name indicating a response to the attribute 911, i.e., “smi 1602-cpca-supported”. The attribute name of the attribute 921 conforms to the IPP. The attribute value of the attribute 921 is the CPCA capability information returned from the CPCA processing unit 611. The attribute value of the attribute 921 conforms to the CPCA.

The attribute name of the attribute 921 starts with “smi”, and the attribute name is therefore an attribute name defined by the vendor. An attribute having an attribute name defined by the vendor in this manner is called a “vendor extension attribute”. The data type of the attribute value of the attribute 921 may be “1setOfoctetString (MAX)”. This data type represents a set of octet strings having a maximum number of characters.

In step S904, the printer management unit 606 of the printing apparatus 120 sends the information response 920 to the information processing apparatus 110 in response to the information request 910, and the information processing apparatus 110 receives the information response 920. In step S905, the printer management unit 405 of the information processing apparatus 110 obtains the CPCA capability information of the printing apparatus 120 from the information response 920, and stores the CPCA capability information in the printer information 411 in association with the printing apparatus 120.

Because the attribute name of the attribute 921 conforms to the IPP, the standard printing function 414 of the information processing apparatus 110 can interpret the attribute 921, and can identify that the attribute value of the attribute 921 represents the CPCA capability information. On the other hand, if the attribute value of the attribute 921 (i.e., the CPCA capability information) does not conform to the IPP, the standard printing function 414 cannot interpret the CPCA capability information. However, because the CPCA capability information conforms to the CPCA, the PSA 413 can interpret the CPCA capability information. The user of the information processing apparatus 110 can therefore instruct the printing apparatus 120 to print using the print settings represented by the CPCA capability information.

When a new print setting is added to the printing apparatus 120 or an existing print setting is changed, the attribute value of the attribute 921 (i.e., the CPCA capability information) changes. Even in such a case, the attribute name of the attribute 921 does not change, so there is no need to update the standard printing function 414. If the PSA 413 is updated to support the new print settings, the user can use the new print settings of the printing apparatus 120. Therefore, according to the foregoing embodiments, the print settings that can be used by the user of the information processing apparatus 110 can be changed in a flexible manner.

As described above, when an information request 910 including the attribute 911 having an attribute name of “requested-attributes” and an attribute value of “smi1602-cpca-supported” is received, the printing apparatus 120 responds to the information processing apparatus 110 with the CPCA capability information including all types of capability information of the printing apparatus 120. However, the types of the capability information of the printing apparatus 120 may instead be divided into groups, and the information processing apparatus 110 may be capable of obtaining the capability information on a group-by-group basis. For example, the capability information of the printing apparatus 120 may be divided into “job”, “binder”, and “document” groups. In this case, when the printing apparatus 120 receives an information request 910 including the attribute having an attribute name of “requested-attributes” and an attribute value of “smi1602-cpca-set_job-supported”, the printing apparatus 120 may respond to the information processing apparatus 110 with the CPCA capability information including the type of capability information belonging to “set_job” of the printing apparatus 120. Even if the type of capability information belonging to “job” is changed, there is no need to change the attribute name of “smi1602-cpca-set_job-supported”, and there is thus no need to update the standard printing function 414. The attribute values of “smi1602-cpca-set_binder-supported” and “smi1602-cpca-set_document-supported” may be defined by the vendor in the same manner for “set_binder” and “set_document”, respectively.

In the example in FIG. 9, the printing apparatus 120 receives the information request 910 from the information processing apparatus 110, which is an external apparatus, and sends the information response 920 to that information processing apparatus 110. On the other hand, the information processing apparatus 110 sends the information request 910 to the printing apparatus 120, which is an external apparatus, and receives the information response 920 from that printing apparatus 120. However, the CPCA capability information of the printing apparatus 120 may instead be provided to the information processing apparatus 110 via the print server 130.

For example, the information update request sent from the printing apparatus 120 to the print server 130 in step S709 in FIG. 7 (e.g., an Update-Output-Device-Attributes request message) may include an attribute 921. In this case, the registration confirmation response sent from the print server 130 to the printing apparatus 120 in step S708 may be deemed to be a message requesting the capability information of the printing apparatus 120. The print server 130 obtains the CPCA capability information of the printing apparatus 120 from the attribute 921 and stores the CPCA capability information in the printer information 311 in association with the printing apparatus 120. The attribute 921 may be included in other messages sent from the printing apparatus 120 to the print server

The information request sent from the information processing apparatus 110 to the print server 130 in step S712 (e.g., the Get-Printer-Attributes Request message) may include the attribute 911. The print response sent from the print server 130 to the information processing apparatus 110 in step S713 in response to the information request (e.g., the Get-Printer-Attributes Response message) may include the attribute 921. The print server 130 may include the CPCA capability information obtained from the printing apparatus 120 in the attribute 921.

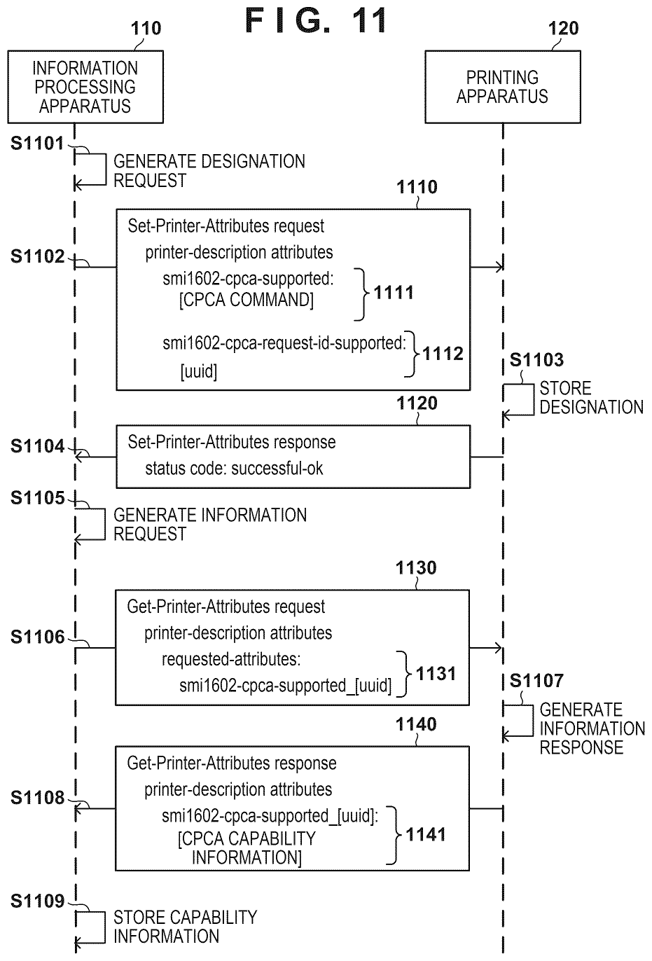

Another specific example of steps S803 and S804 illustrated in FIG. 8 will be described with reference to FIG. 10. Steps S1001 to S1006 in FIG. 10 are executed in step S803 in FIG. 8, and steps S1007 to S1009 in FIG. 10 are executed in step S804 in FIG. 8.

In the method illustrated in FIG. 9, when the message requesting information about the printing apparatus 120 (e.g., the information request 910) includes the attribute 911, the printing apparatus 120 responds with a preset type of the CPCA capability information. However, in the method illustrated in FIG. 10, the information processing apparatus 110 can specify the type of capabilities that the printing apparatus 120 includes in the CPCA capability information.

In step S1001, the standard printing function 414 of the information processing apparatus 110 generates a designation request 1010. The designation request 1010 is a message designating the type of the capability information of the printing apparatus 120. In the example in FIG. 10, the designation request 1010 is a Set-Printer-Attributes Request message defined by the IPP.

The designation request 1010 includes an attribute 1011. The attribute 1011 is an attribute for designating the type of the capability information of the printing apparatus 120. The attribute name of the attribute 1011 is “smi1602-cpca-supported”. The attribute name of the attribute 1011 conforms to the IPP. The attribute value of the attribute 1011 designates the type of the capability information of the printing apparatus 120. In the example in FIG. 10, the attribute value of the attribute 1011 conforms to the CPCA. The attribute value of the attribute 1011 may be a command that can be executed by the CPCA processing unit 611 of the printing apparatus 120. A command that can be executed by the CPCA processing unit 611 will be referred to as a “CPCA command” hereinafter.

To generate the designation request 1010, the standard printing function 414 queries the PSA 413 of the printing apparatus 120. The PSA 413 generates the CPCA command in response to the query. The PSA 413 may query the user of the information processing apparatus 110 about the type of the capability information to be obtained, or may determine that a type of the capability information set in the PSA 413 in advance is to be obtained. The standard printing function 414 generates the designation request 1010 including the attribute 1011, which includes the CPCA command generated by the PSA 413.

In step S1002, the printer management unit 405 of the information processing apparatus 110 sends the designation request 1010 to the printing apparatus 120, and the printing apparatus 120 receives the designation request 1010. For example, the printer management unit 405 of the information processing apparatus 110 sends the designation request 1010 to the printing apparatus 120 having designated the port number assigned to the IPP processing unit 610 of the printing apparatus 120. In this case, the designation request 1010 is passed to the IPP processing unit 610 of the printing apparatus 120.

In step S1003, the IPP processing unit 610 of the printing apparatus 120 identifies that the type of the capability information is designated, based on the designation request 1010 including the attribute “requested-attributes” (the attribute 1011, in the example in FIG. 10). The IPP processing unit 610 then stores the attribute value of the attribute 1011 (the CPCA command) in association with the information processing apparatus 110. For example, the IPP processing unit 610 stores the attribute value of the attribute 1011 in association with the source Internet Protocol (IP) address of the designation request 1010 (the IP address of the information processing apparatus 110, in the example in FIG. 10).

In step S1004, the printer management unit 606 of the printing apparatus 120 sends a designation response 1020 to the information processing apparatus 110 in response to the designation request 1010, and the information processing apparatus 110 receives the designation response 1020. In the example in FIG. 10, the designation response 1020 is a Set-Printer-Attributes Response message defined by the IPP. The designation response 1020 indicates that the type of the capability information has been properly designated.

In step S1005, the standard printing function 414 of the information processing apparatus 110 generates an information request 1030 in response to the designation response 1020 being received. The information request 1030 and an attribute 1031 may be the same as the information request 910 and the attribute 911, respectively, and thus redundant descriptions thereof will be omitted.

In step S1006, the printer management unit 405 of the information processing apparatus 110 sends the information request 1030 to the printing apparatus 120, and the printing apparatus 120 receives the information request 1030. For example, the printer management unit 405 of the information processing apparatus 110 sends the information request 1030 to the printing apparatus 120 by specifying the port number assigned to the IPP processing unit 610 of the printing apparatus 120. In this case, the information request 1030 is passed to the IPP processing unit 610 of the printing apparatus 120.

In step S1007, the IPP processing unit 610 of the printing apparatus 120 generates an information response 1040 in response to the information request 1030 being received. The information response 1040 includes the capability information of the printing apparatus 120. In the example in FIG. 10, the information response 1040 is a Get-Printer-Attributes Response message defined by the IPP.

First, the IPP processing unit 610 identifies that the capability information of the printing apparatus 120 is being requested based on the information request 1030 being received. The IPP processing unit 610 further identifies that the CPCA capability information is being requested based on the attribute value of the attribute “requested-attributes” being “smi 1602-cpca-supported” (i.e., the information request 1030 including the attribute 1031). The IPP processing unit 610 then determines whether the designation request 1010 associated with the information request 1030 is present.

For example, the IPP processing unit 610 may associate the designation request 1010 and the information request 1030 which have the same source IP address with each other. In particular, the IPP processing unit 610 may determine whether the designation request 1010 having the same source IP address as the information request 1030 has been received before the information request 1030 is received. If such a designation request 1010 has been received, the IPP processing unit 610 may associate the designation request 1010 and the information request 1030 with each other.

The association of the designation request 1010 and the information request 1030 may be subject to a time requirement. For example, the IPP processing unit 610 may skip associating the designation request 1010 and the information request 1030 with each other if the difference between the reception time of the designation request 1010 and the reception time of the information request 1030 is greater than a threshold (e.g., 10 seconds). If a plurality of designation requests 1010 have been received before the information request 1030, the IPP processing unit 610 may associate the designation request 1010 received last with the information request 1030.

If the designation request 1010 associated with the information request 1030 is present, the IPP processing unit 610 queries the CPCA processing unit 611 for the CPCA capability information of the type designated by the attribute 1011 of the designation request 1010. This query may be made using the port number of the CPCA processing unit 611, or may be made using the API of the CPCA processing unit 611. For example, the IPP processing unit 610 may pass a CPCA command stored in association with the IP address of the information processing apparatus 110 to the CPCA processing unit 611.

The CPCA processing unit 611 obtains the CPCA capability information of the printing apparatus 120 from the printer information 621 by executing the CPCA command received from the IPP processing unit 610, and returns the CPCA capability information to the IPP processing unit 610. The CPCA capability information is capability information of the type designated by the attribute 1011.

If the designation request 1010 associated with the information request 1030 is not present, the IPP processing unit 610 may query the CPCA processing unit 611 for the CPCA capability information of a type set in advance. The type of the CPCA capability information set in advance may be any type of CPCA capability information.

The IPP processing unit 610 generates the information response 1040 based on the CPCA capability information returned from the CPCA processing unit 611. Specifically, the information response 1040 includes an attribute 1041. The attribute name of the attribute 1041 is an attribute name indicating a response to the attribute 1031, i.e., “smi1602-cpca-supported”. The attribute name of the attribute 1041 conforms to the IPP. The attribute value of the attribute 921 is the CPCA capability information returned from the CPCA processing unit 611. The attribute value of the attribute 921 conforms to the CPCA. Steps S1008 and S1009 may be the same as steps S904 and S905, and thus redundant descriptions thereof will be omitted.

As in FIG. 9, the attribute “smi1602-cpca-set_job-supported” or the like may be used instead of the attribute “smi1602-cpca-supported”. If the attribute “smi1602-cpca-set_job-supported” is used, the printing apparatus 120 may respond to the information processing apparatus 110 with the CPCA capability information including the capability information of the type designated by the attribute 1011, among the types of capability information belonging to “job” of the printing apparatus 120.

In the example in FIG. 10, the attribute name of the attribute 1011 and the attribute name of the attribute 1041 are both “smi1602-cpca-supported”, but these may be different. In the example in FIG. 10, the information processing apparatus 110 sends a designation request 1110, and then sends an information request 1130 associated with the designation request 1110. However, the information processing apparatus 110 may instead send the information request 1130, and then send the designation request 1110 associated with the information request 1130. If the information processing apparatus 110 is configured in this manner, the printing apparatus 120 may associate the designation request 1110 received after the information request 1130 was received with the information request 1130.

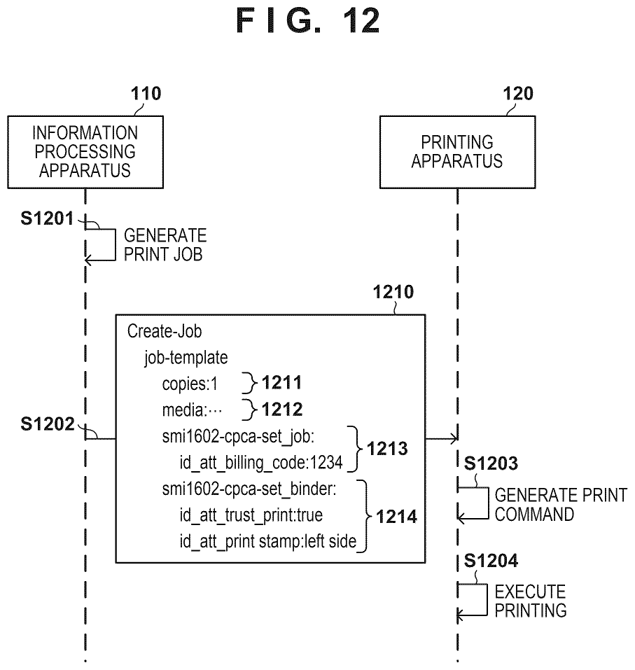

Another specific example of steps S803 and S804 illustrated in FIG. 8 will be described with reference to FIG. 11. Steps S1101 to S1106 in FIG. 11 are executed in step S803 in FIG. 8, and steps S1107 to S1109 in FIG. 11 are executed in step S804 in FIG. 8. Like the method illustrated in FIG. 10, in the method illustrated in FIG. 11, the information processing apparatus 110 can designate the type of capabilities that the printing apparatus 120 includes in the CPCA capability information. The variation described as the method illustrated in FIG. 10 can also be applied in the method illustrated in FIG. 11.

In step S1101, the standard printing function 414 of the information processing apparatus 110 generates the designation request 1110. The designation request 1110 is a message designating the type of the capability information of the printing apparatus 120. In the example in FIG. 11, the designation request 1110 is a Set-Printer-Attributes Request message defined by the IPP.

The designation request 1110 includes an attribute 1111. The attribute 1111 may be the same as the attribute 1011, and thus redundant descriptions thereof will be omitted. The designation request 1110 further includes an attribute 1112. The attribute 1112 is an attribute for designating a Universally Unique Identifier (UUID) used to associate the designation request 1110 and the information request 1130 with each other. The attribute name of the attribute 1112 is “smi1602-cpca-request-id-supported”. The attribute name of the attribute 1112 conforms to the IPP. The attribute value of the attribute 1112 is the UUID generated by the standard printing function 414. The standard printing function 414 generates the UUID each time step S1101 is executed.

In step S1102, the printer management unit 405 of the information processing apparatus 110 sends the designation request 1110 to the printing apparatus 120, and the printing apparatus 120 receives the designation request 1110. For example, the printer management unit 405 of the information processing apparatus 110 sends the designation request 1110 to the printing apparatus 120 having designated the port number assigned to the IPP processing unit 610 of the printing apparatus 120. In this case, the designation request 1110 is passed to the IPP processing unit 610 of the printing apparatus 120.

In step S1103, the IPP processing unit 610 of the printing apparatus 120 identifies that the type of the capability information is designated, based on the designation request 1110 including the attribute “requested-attributes” (the attribute 1111, in the example in FIG. 11). The IPP processing unit 610 then stores the attribute value of the attribute 1111 (the CPCA command) in association with the information processing apparatus 110. For example, the IPP processing unit 610 stores the attribute value of the attribute 1111 in association with the attribute value of the attribute 1112 of the designation request 1110 (i.e., the UUID).

In step S1104, the printer management unit 606 of the printing apparatus 120 sends a designation response 1120 to the information processing apparatus 110 in response to the designation request 1110, and the information processing apparatus 110 receives the designation response 1120. In the example in FIG. 11, the designation response 1120 is a Set-Printer-Attributes Response message defined by the IPP. The designation response 1120 indicates that the type of the capability information has been properly designated.

In step S1105, the standard printing function 414 of the information processing apparatus 110 generates an information request 1130 in response to the designation response 1120 being received. The information request 1130 includes an attribute 1131 indicating a request for the capability information expressed in a format conforming to the CPCA. The attribute 1131 also includes information for associating the information request 1130 with the designation request 1110 (specifically, the UUID, which is the attribute value of the attribute 1112).

In the example in FIG. 11, the attribute name of the attribute 1131 is “requested-attributes”. The attribute name of the attribute 1131 conforms to the IPP. The attribute value of the attribute 1131 is “smi1602-cpca-supported_[uuid]”. [uuid] is the same value as the attribute value of the attribute 1112. The attribute value of the attribute 1131 conforms to the IPP. Because both the attribute name and the attribute value of the attribute 1131 conform to the IPP in this manner, the standard printing function 414 can generate an information request 1130 including the attribute 1131.

In step S1106, the printer management unit 405 of the information processing apparatus 110 sends the information request 1130 to the printing apparatus 120, and the printing apparatus 120 receives the information request 1130. For example, the printer management unit 405 of the information processing apparatus 110 sends the information request 1130 to the printing apparatus 120 by specifying the port number assigned to the IPP processing unit 610 of the printing apparatus 120. In this case, the information request 1130 is passed to the IPP processing unit 610 of the printing apparatus 120.

In step S1107, the IPP processing unit 610 of the printing apparatus 120 generates an information response 1140 in response to the information request 1130 being received. The information response 1140 includes the capability information of the printing apparatus 120. In the example in FIG. 11, the information response 1140 is a Get-Printer-Attributes Response message defined by the IPP.

First, the IPP processing unit 610 identifies that the capability information of the printing apparatus 120 is being requested based on the information request 1130 being received. The IPP processing unit 610 further identifies that the CPCA capability information is being requested based on the attribute value of the attribute “requested-attributes” starting from “smi1602-cpca-supported” (i.e., the information request 1130 including the attribute 1131). The IPP processing unit 610 then determines whether the designation request 1110 associated with the information request 1130 is present.

For example, the IPP processing unit 610 may associate the designation request 1110 and the information request 1130 which include the same UUID with each other. Specifically, the IPP processing unit 610 may determine whether the designation request 1110 including the UUID added to the attribute value starting with “smi1602-cpca-supported”, of the attribute “requested-attributes” included in the information request 1130, has been received. If such a designation request 1110 has been received, the IPP processing unit 610 may associate the designation request 1110 and the information request 1130 with each other.

The processing performed when the designation request 1110 associated with the information request 1130 is present, and when the designation request 1110 associated with the information request 1130 is not present, may be the same as in FIG. 10, and thus redundant descriptions thereof will be omitted. An information response 1140 may be the same as the information response 1040, and thus redundant descriptions thereof will be omitted. Aside from the attribute name including the UUID, an attribute 1141 may be the same as the attribute 1041, and thus redundant descriptions thereof will be omitted. Steps S1108 and S1109 may be the same as steps S904 and S905, and thus redundant descriptions thereof will be omitted.

In the example in FIG. 11, the printing apparatus 120 receives the designation request 1110 and the information request 1130 from the information processing apparatus 110, which is an external apparatus, and sends the information response 1140 to that information processing apparatus 110. On the other hand, the information processing apparatus 110 sends the designation request 1110 and the information request 1130 to the printing apparatus 120, which is an external apparatus, and receives the information response 1140 from that printing apparatus 120. However, the CPCA capability information of the printing apparatus 120 may instead be provided to the information processing apparatus 110 via the print server 130.

For example, the information processing apparatus 110 may send the designation request 1110 to the print server 130. The print server 130 may send a message including the attribute 1111 and the attribute 1112 to the printing apparatus 120 specified in the designation request 1110. In response to this message, the printing apparatus 120 may send a message including the attribute 1141 to the print server 130. The print server may send a message including the attribute 1141 to the information processing apparatus 110.

Operations by which Information Processing Apparatus Submits Print Job to Printing Apparatus

A specific example of steps S805 and S806 illustrated in FIG. 8 will be described with reference to FIG. 12. Steps S1201 and S1202 in FIG. 12 are executed in step S805 in FIG. 8, and steps S1203 and S1204 in FIG. 12 are executed in step S806 in FIG. 8.

In step S1201, the print control unit 404 of the information processing apparatus 110 generates a print job 1210. The print job 1210 includes print settings and print data. In the example in FIG. 12, the print job 1210 includes a plurality of attributes 1211 to 1214, each representing a print setting. The plurality of attributes 1211 to 1214 may be included in a Create-Job message defined by the IPP.

The attribute 1211 represents the print settings supported by the standard printing function 414. Both the attribute name and the attribute value of the attribute 1211 conform to the IPP. The standard printing function 414 is capable of generating the attribute 1211. An attribute representing print settings supported by the standard printing function 414 in this manner will be referred to as an “IPP standard attribute”. Both the attribute name and the attribute value of the IPP standard attribute are defined by the IPP. Like the attribute 1211, the attribute 1212 is an IPP standard attribute.

The attribute 1213 represents print settings supported by the PSA 413. The attribute name of the attribute 1213 conforms to the IPP. The attribute name of the attribute 1213 is an attribute name defined by the vendor of the printing apparatus 120.

The attribute 1213 is therefore a vendor extension attribute. The attribute value of the attribute 1213 conforms to the CPCA. For example, the attribute value of the attribute 1213 is a CPCA command for causing the printing apparatus 120 to apply the print settings. As described above, a CPCA command is a command that can be executed by the CPCA processing unit 611. A vendor extension attribute in which the attribute value is a CPCA command, as is the case with the attribute 1213, will be referred to as a “CPCA attribute”. The attribute 1213 includes the CPCA command “id_att_billing_code: 1234” as an attribute value corresponding to the attribute name “smi1602-cpca-set_job” of the attribute 1213. This CPCA command is an attribute conforming to the CPCA. Specifically, this CPCA command includes an attribute name “id_att_billing_code” conforming to the CPCA and an attribute value “1234” conforming to the CPCA. The attribute 1213 represents one type of the print settings of the printing apparatus 120. Like the attribute 1213, the attribute 1214 is a CPCA attribute. The attribute value corresponding to the attribute name “id_att_trust_print” of the CPCA command can take on a value of “true” and “false”. The attribute value corresponding to the attribute name “id_att_print stamp” of the CPCA command can take on a value of “left side” and “right side”.

The attribute 1214 represents a plurality (two, in the example in FIG. 12) of types of the print settings of the printing apparatus 120.

The print settings included in the print job 1210 may be divided into a plurality of groups. For example, the print settings included in the print job 1210 may be divided into “job”, “binder”, and “document” groups. The CPCA processing unit 611 of the printing apparatus 120 may execute commands pertaining to the print settings for each of these groups.

The CPCA attribute may be defined for each group of print settings. For example, for “job”, “binder”, and “document”, “smi1602-cpca-set_job”, “smi1602-cpca-set_binder”, and “smi1602-cpca-set_document” may be defined as the attribute names, respectively. The data type of the attribute values of these CPCA attributes may be “1 setOfoctetString (MAX)”. The attribute value of the attribute “smi1602-cpca-set_job” may be, for example, “id_att_print_numberstring: position: bottom, font: gothic, fontcolor: black”, “id_att_print_stamp: stampstring: ‘confidential’”, “id_att_trust_print: truststring: ‘COPY’”, or the like.

The PSA 413 obtains a designation of the print settings from the user of the information processing apparatus 110, and generates the CPCA attributes of the print job 1210 based on this designation. Specifically, the PSA 413 generates a CPCA command for causing the printing apparatus 120 to apply the print settings designated by the user.

The PSA 413 also determines the group to which the CPCA command belongs (e.g., “job”) and generates an attribute according to the group (e.g., the attribute “smi1602-cpca-set_job”).

The standard printing function 414 obtains a designation of the print settings from the user of the information processing apparatus 110, and generates the IPP standard attributes of the print job 1210 based on this designation. The print control unit 404 generates the print job 1210 so as to include the CPCA attributes generated by the PSA 413 and the IPP standard attributes generated by the standard printing function 414. In the example in FIG. 12, the print job 1210 includes both the IPP standard attributes and the CPCA attributes. Instead, however, the configuration may be such that the print job 1210 does not include the IPP standard attributes, or does not include the CPCA attributes.

In step S1202, the print control unit 404 of the information processing apparatus 110 sends the print job 1210 to the printing apparatus 120, and the printing apparatus 120 receives the print job 1210. For example, the print control unit 404 of the information processing apparatus 110 sends the print job 1210 to the printing apparatus 120 having designated the port number assigned to the IPP processing unit 610 of the printing apparatus 120. In this case, the print job 1210 is passed to the IPP processing unit 610 of the printing apparatus 120.

In step S1203, the IPP processing unit 610 of the printing apparatus 120 generates a print command based on the plurality of attributes 1211 to 1214 included in the print job 1210 received in step S1202. In step S1204, the CPCA processing unit 611 of the printing apparatus 120 prints the print data designated in the print job 1210 in accordance with the print command generated in step S1203.

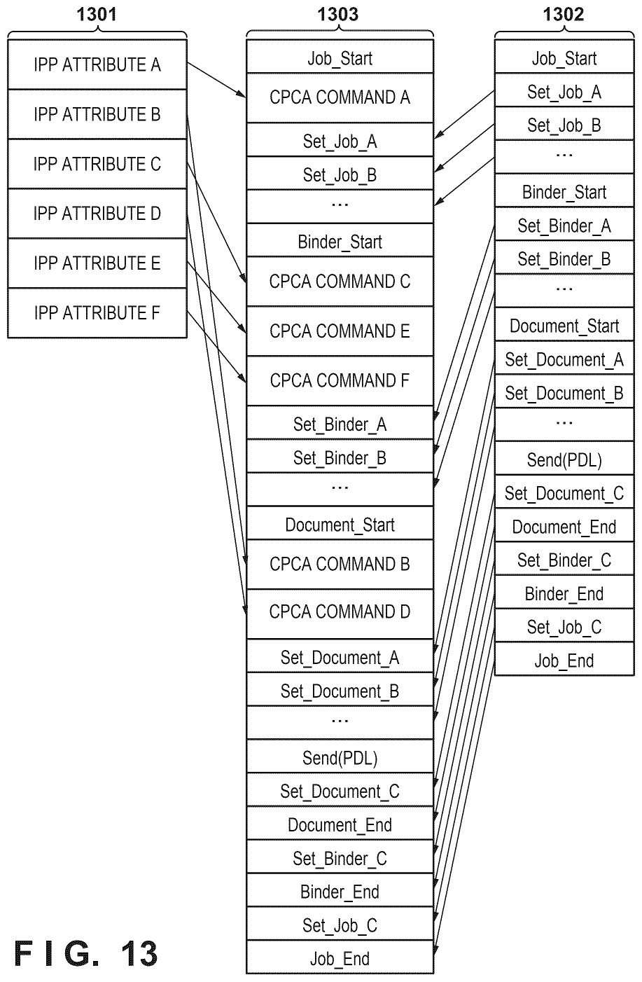

Processing for generating the print command, performed in step S1203, will be described in detail with reference to FIG. 13. An IPP standard attribute set 1301 represents a set of at least one IPP standard attribute included in the print job 1210. The IPP standard attribute set 1301 can include the attribute 1211 and the attribute 1212 in FIG. 12. A CPCA attribute set 1302 represents a set of at least one CPCA attribute included in the print job 1210. The CPCA attribute set 1302 can include the attribute 1213 and the attribute 1214 in FIG. 12. A print command 1303 represents a print command generated based on the IPP standard attribute set 1301 and the CPCA attribute set 1302.

The print command 1303 includes commands for each group of print settings. As illustrated in FIG. 13, the print command 1303 includes, in order from the beginning, commands belonging to the group “job”, commands belonging to the group “binder”, and commands belonging to the group “document”.

The IPP processing unit 610 converts each IPP standard attribute included in the IPP standard attribute set 1301 into a CPCA command, and includes those CPCA commands in the print command 1303. The IPP processing unit 610 determines the groups to which the post-conversion CPCA commands are to belong, and includes the CPCA commands in the positions of the determined groups.

The IPP processing unit 610 includes the attribute value of each IPP standard attribute (which are CPCA commands), which are included in the CPCA attribute set 1302, in the print command 1303. The IPP processing unit 610 determines the groups to which the CPCA commands are to belong based on the attribute names of the respective IPP standard attributes, and includes the CPCA commands in the positions of the determined groups.

If the print settings represented by the IPP standard attributes conflict with the print settings represented by the CPCA attributes, the IPP processing unit 610 may print the print data in accordance with the print settings represented by the CPCA attributes. For example, if the print settings represented by the IPP standard attributes conflict with the print settings represented by the CPCA attributes, the IPP processing unit 610 may skip including the print settings represented by the IPP standard attributes in the print command 1303. Instead, however, if the print settings represented by the IPP standard attributes conflict with the print settings represented by the CPCA attributes, the IPP processing unit 610 may cause the print settings represented by the IPP standard attributes to be overwritten with the print settings represented by the CPCA attributes.

When a new print setting is added to the printing apparatus 120 or an existing print setting is changed, the attribute value (i.e., the CPCA command) of the CPCA attribute (e.g., the attribute 1213) changes. Even in such a case, the attribute name of the CPCA attribute does not change, so there is no need to update the standard printing function 414. If the PSA 413 is updated to support the new print settings, the user can use the new print settings of the printing apparatus 120. Therefore, according to the foregoing embodiments, the print settings that can be used by the user of the information processing apparatus 110 can be changed in a flexible manner.

In the example in FIG. 12, the information processing apparatus 110 sends the print job 1210 to the printing apparatus 120, which is an external apparatus. The printing apparatus 120 receives the print job 1210 from the information processing apparatus 110, which is an external apparatus. However, the print job 1210 may instead be provided to the printing apparatus 120 from the information processing apparatus 110 via the print server 130.

For example, the print request sent from the information processing apparatus 110 to the print server 130 in step S714 in FIG. 7 may include the attributes 1211 to 1214. Furthermore, the print job response sent from the print server 130 to the printing apparatus 120 in step S717 in FIG. 7 may include the attributes 1211 to 1214.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-095377, filed Jun. 12, 2024, which is hereby incorporated by reference herein in its entirety.

What is claimed is:

1. A printing apparatus comprising:
a receiving unit configured to receive, from an external apparatus, a print job including a first attribute representing a print setting;
a generating unit configured to generate a print command based on the first attribute; and
a printing unit configured to print print data designated by the print job, in accordance with the print command,
wherein the first attribute includes an attribute name conforming to a first protocol; and
an attribute name and an attribute value conforming to a second protocol different from the first protocol are included as an attribute value corresponding to the attribute name of the first attribute.

2. The printing apparatus according to claim 1,
wherein the attribute name of the first attribute is an attribute name defined by a vendor of the printing apparatus, and
the attribute value of the first attribute represents a plurality of types of print settings of the printing apparatus.

3. The printing apparatus according to claim 1,
wherein generating the print command based on the first attribute includes including the attribute value of the first attribute in the print command.

4. The printing apparatus according to claim 1,
wherein the print job further includes a second attribute representing a print setting,
the second attribute includes an attribute name and an attribute value conforming to the first protocol, and
the generating unit is configured to generate the print command further based on the second attribute.

5. The printing apparatus according to claim 4,
wherein generating the print command based on the second attribute includes converting the second attribute to a command conforming to the second protocol and including the command in the print command.

6. The printing apparatus according to claim 4,
wherein in a case where the print setting represented by the first attribute conflicts with the print setting represented by the second attribute, the printing unit is configured to print the print data in accordance with the print setting represented by the first attribute.

7. The printing apparatus according to claim 1,
wherein the generating unit is configured to:
divide print settings included in the print job into a plurality of groups; and
determine a group, among the plurality of groups, to which the print setting represented by the first attribute is to belong based on the attribute name of the first attribute.

8. The printing apparatus according to claim 1,
wherein the first protocol is a protocol supported by a standard printing function of an operating system of an information processing apparatus that generates the print job, and
the second protocol is a protocol not supported by the standard printing function.

9. The printing apparatus according to claim 8,
wherein the second protocol is a proprietary protocol of a vendor of the printing apparatus.

10. The printing apparatus according to claim 8,
wherein the first protocol is the Internet Printing Protocol.

11. A method for controlling a printing apparatus, the method comprising:
receiving, from an external apparatus, a print job including a first attribute representing a print setting;
generating a print command based on the first attribute; and
printing print data designated by the print job, in accordance with the print command,
wherein the first attribute includes an attribute name conforming to a first protocol; and
an attribute name and an attribute value conforming to a second protocol different from the first protocol are included as an attribute value corresponding to the attribute name of the first attribute.

12. An information processing apparatus comprising:
a generating unit configured to generate a print job including a first attribute representing a print setting; and
a sending unit configured to send the print job to a printing apparatus or a print server,
wherein the first attribute includes an attribute name conforming to a first protocol; and
an attribute name and an attribute value conforming to a second protocol different from the first protocol are included as an attribute value corresponding to the attribute name of the first attribute.

13. A non-transitory computer-readable storage medium having stored therein a program for causing a computer to function as the information processing apparatus according to claim 12.

14. A method for controlling an information processing apparatus, the method comprising:
generating a print job including a first attribute representing a print setting; and
sending the print job to a printing apparatus or a print server,
wherein the first attribute includes an attribute name conforming to a first protocol; and
an attribute name and an attribute value conforming to a second protocol different from the first protocol are included as an attribute value corresponding to the attribute name of the first attribute.
